(19) United States
(12) Patent Application Publication
(10) Pub. No.: US 2026/0264751 A1
(43) Pub. Date: Sep. 10, 2026

(54) METHODS AND APPARATUS FOR A STEER-BY-WIRE STEERING SYSTEM

(71) Applicant: Ford Global Technologies, LLC, Dearborn, MI (US)

(72) Inventors: Alexander Ein Waldt, Köln (DE); Gerhard Friederich, Bornheim (DE); Oliver Nehls, Düsseldorf (DE); Sergio Codonesu, Aachen (DE); Goetz-Philipp Wegner, Dortmund (DE)

(21) Appl. No.: 19/456,663

(22) Filed: Jan. 22, 2026

(30) Foreign Application Priority Data
Feb. 19, 2025 (DE) 102025106303.6

(51) Int. Cl. B62D 6/00

(52) U.S. Cl. CPC B62D 6/008; B62D 6/007

(57) ABSTRACT

The disclosure generally relates to steer-by-wire steering systems and, more particularly, to methods and apparatus for a steer-by-wire steering system. An example vehicle comprising a hand wheel actuator, a road wheel actuator, and a control device configured to determine a first feedback torque to be applied by the hand wheel actuator based on an actual rack and pinion force applied by the road wheel actuator, determine a second feedback torque to be applied by the hand wheel actuator based on the first feedback torque and a driving mode associated with the vehicle, and cause the hand wheel actuator to generate a feedback torque to a steering wheel of the vehicle based on the second feedback torque.

### RELATED APPLICATION

This patent claims priority from DE Patent Application Number 102025106303.6, which was filed on Feb. 19, 2025, and is hereby incorporated by reference in its entirety.

### FIELD OF THE DISCLOSURE

The disclosure generally relates to steer-by-wire steering systems and, more particularly, to methods and apparatus for a steer-by-wire steering system.

### BACKGROUND

Steer-by-wire systems replace the mechanical connection between the steering wheel and the steerable road wheels with electronic sensing, control, and actuation, allowing steering characteristics to be flexibly adapted to different vehicles, operating conditions, and driving modes. Software-based generation of steering feedback provides configurability of feel and integration of advanced vehicle control functions.

### SUMMARY

An example vehicle comprising a hand wheel actuator, a road wheel actuator, and a control device configured to determine a first feedback torque to be applied by the hand wheel actuator based on an actual rack and pinion force applied by the road wheel actuator, determine a second feedback torque to be applied by the hand wheel actuator based on the first feedback torque and a driving mode associated with the vehicle, and cause the hand wheel actuator to generate a feedback torque to a steering wheel of the vehicle based on the second feedback torque.

An example non-transitory computer readable storage medium comprising instructions to cause at least one programmable circuitry to determine a first feedback torque to be applied by a hand wheel actuator of a vehicle based on an actual rack and pinion force applied by a road wheel actuator of the vehicle, determine a second feedback torque to be applied by the hand wheel actuator based on the first feedback torque and a driving mode associated with the vehicle, and cause the hand wheel actuator to generate a feedback torque to a steering wheel of the vehicle based on the second feedback torque.

An example method comprising determining a first feedback torque to be applied by a hand wheel actuator of a vehicle based on an actual rack and pinion force applied by a road wheel actuator of the vehicle, determining a second feedback torque to be applied by the hand wheel actuator based on the first feedback torque and a driving mode associated with the vehicle, and causing the hand wheel actuator to generate a feedback torque to a steering wheel of the vehicle based on the second feedback torque.

### BRIEF DESCRIPTION OF DRAWINGS

FIG. 1 a schematic representation of a vehicle with a steer-by-wire steering system constructed in accordance with examples disclosed herein.

FIG. 2 is a flowchart representative of example machine readable instructions and/or example operations that may be executed, instantiated, and/or performed by example programmable circuitry to implement the control device of FIG. 1.

FIG. 3 is a block diagram of an example processing platform including programmable circuitry structured to execute, instantiate, and/or perform the example machine readable instructions and/or perform the example operations of FIG. 2 to implement the control device of FIG. 1.

### DETAILED DESCRIPTION

Steer-by-wire steering systems (hereinafter SBW steering systems) are a steering technology that eliminate a direct mechanical connection between a steering wheel and road wheels of a vehicle. The direct connection is replaced by two actuators, a hand wheel actuator and a road wheel actuator. The hand wheel actuator generates feedback torque for the driver on the steering wheel, and the road wheel actuator regulates at least one, but typically several, steerable road wheels to a desired position. The feedback torque gives a driver of the vehicle a feeling about control of the vehicle.

In vehicles with conventional steering systems, changes in vehicle speed can cause unwanted forces at the steering wheel. The unwanted forces are generated by the drive torques and/or speed reduction torques of the vehicle via the chassis geometry, the steering geometry, and the specific stiffnesses. Such unwanted forces are also known as torque steer. In some operating modes, such as a race mode or a sport mode, torque steer can be beneficial for the driver because it provides more direct and immediate feedback from the vehicle's lateral guidance, which more accurately and realistically reflects the vehicle's condition at the physical limit.

SBW steering systems enable the decoupling of the feedback torque applied to the steering wheel from the immediate road feedback, which is unavoidable with conventional steering systems because of the mechanical connection. Therefore, the rack and pinion forces exerted by a road wheel actuator are only partially considered in SBW steering systems. As a result, the feedback torque (e.g., steering torque) applied to a steering wheel by means of the hand wheel actuator is lower than that of conventional steering systems, in which corresponding torques are caused by direct mechanical coupling. The decoupling provided by previous SBW steering systems therefore reduces the road, chassis, and powertrain-induced unwanted forces imparted to the SBW steering system and the steering wheel and, therefore, attenuates the feedback torque felt by the driver and thus the feedback about the vehicle's condition. Therefore, based on known SBW steering systems for vehicles operated at the physical limit, the driver does not receive feedback on the vehicle's lateral guidance compared to conventional steering systems. This can make it relatively difficult to operate the vehicle at or near the physical limit (e.g., at high vehicle speeds and/or high-speed change values while maintaining vehicle control).

Examples disclosed herein enable precise and direct feedback regarding the vehicle steering during vehicle speed changes. According to one aspect, some examples of the disclosure relate to a method for operating a SBW steering system for a vehicle. The SBW steering system includes at least one road wheel actuator, one hand wheel actuator, and one control device coupled to the road wheel actuator and the hand wheel actuator. The method includes at least the following operations. First, user input is received by the control device using a user interface and at least one driving mode is specified based on the user input. Then, a conventional feedback torque to be applied by the hand wheel actuator is determined by the control device based on an actual rack and pinion force applied. A feedback torque to be applied by the hand wheel actuator is then estimated by the control device. The feedback torque is adjusted based on a torque steer fraction that depends on the driving mode specified by the user input. The adjusted feedback torque is then output by the hand wheel actuator on the steering wheel of the SBW steering system based on a hand wheel actuator signal generated by the control device to the hand wheel actuator.

The method is based on the knowledge that the control device of the SBW steering system can be used to determine a feedback torque adapted and optimized for a vehicle condition, which is at least indirectly applied to the steering wheel. To do this, the control device only needs information about the driving mode in which the driver intends to operate the vehicle. Since there is no direct mechanical coupling between the steering wheel and the steerable road wheels in SBW steering systems, the required rack and pinion force may be determined by the control device using a control model. This control model can be used to determine the torque-steer proportion measured in each case in the driving mode based on the driving mode and to adjust the feedback torque accordingly. In the following, the torque-steer component refers to the proportion of the feedback torque that is considered to adjust the feedback torque. Based on the torque steer component, the feedback torque can be increased or reduced to tailor the feedback on the steering wheel for the driver, especially depending on the driving mode.

In some examples, the control device can be used to influence how direct and immediate the control of the SBW steering system is for the respective driving mode. This allows the driver to have a more precise and accurate feeling about the vehicle's lateral control, so that he can control the vehicle precisely even at or near the physical limit of the vehicle. Such adapted steering behavior is not achieved by previous SBW steering systems, as these typically provide for a weakening of the feeling felt by the driver via the vehicle lateral guidance. This makes it more difficult for the driver to control the vehicle at or near the physical limit of the vehicle. In a SBW steering system, the SBW steering system can choose whether and how much torque steer is provided to the steering wheel depending on the desired functioning of the SBW steering system, the operating parameters of the vehicle, and/or the selected driving mode. This allows the feedback torque to be tailored to the specific vehicle and driving situation, optimizing comfort for the driver.

According to a further aspect, some examples of the disclosure relate to a SBW steering system for a vehicle. The SBW steering system includes at least one road wheel actuator, one hand wheel actuator, and one control device coupled to the road wheel actuator and the hand wheel actuator. The control device is configured to first receive a user input using a user interface. Then, at least specify one driving mode based on the user input and determine a conventional feedback torque to be applied by the hand wheel actuator based on an actual rack and pinion force applied. Then estimate a feedback torque to be applied by the hand wheel actuator, where the feedback torque is adjusted based on a torque steer fraction that depends on the driving mode specified by the user input. Additionally, the control device is configured to output a signal to the hand wheel actuator based on the adjusted feedback torque. The hand wheel actuator is configured to output the adjusted feedback torque on a steering wheel of the steer-by-wire steering system based on the hand wheel actuator.

The benefits achieved by the method described herein are also achieved in a corresponding manner by the SBW steering system. This ensures the possibility of adaptive adjustment of the vehicle lateral guidance depending on the driving mode using the SBW steering system. This enables direct feedback for the driver and can thus replicate the behavior of a conventional steering system that has a mechanical coupling between the steering wheel and the road wheels.

The road wheel actuator is at least indirectly coupled to a steerable road wheel. In some examples, the road wheel actuator can also be coupled at the same time, at least indirectly, with several steerable road wheels, for example via a steering rack. The road wheel actuator can deliver a rack and pinion force that at least indirectly causes or stabilizes a specific orientation of the steerable road wheels. For example, the rack and pinion force can be used to reposition the rack and pinion force, which causes a reorientation of the steerable road wheels, i.e. a rotation around the vehicle's vertical axis. In some examples, the vehicle may also include a second road wheel actuator, which can be coupled, for example, to steerable rear wheels of the vehicle, for example via an additional steering rack. The multiple road wheel actuators can be controlled together by the control device.

Each road wheel actuator has an electric motor to apply torque to change the orientation of the steerable road wheels. As an example, the road wheel actuator can apply the torque to the rack to adjust the rack position as required. For example, the electric motor can have a winding set with three windings (e.g., a three-phase winding set). Alternatively, the electric motor can also include more than three winding sets.

The hand wheel actuator is configured to apply feedback torque to the steering wheel, at least indirectly, for example via a steering column coupled to the steering wheel. The feedback torque caused by the hand wheel actuator is also used to give the driver torque feedback via the vehicle's lateral guidance. In general, the hand wheel actuator includes an electric motor to apply the feedback torque to the steering wheel. For example, the electric motor can have a winding set with three windings.

In some examples, the SBW steering system can include at least one steering wheel sensor that is configured to detect a steering wheel angle (e.g., a steering wheel position) of the steering wheel and transmit it to the control device. This enables the control device to determine what the driver's steering input is and what rack and pinion force is required for the SBW steering system to follow the steering input. In some examples, the steering input can be based on the steering wheel position of a steering wheel of the SBW steering system.

In some examples, the vehicle and/or the SBW steering system includes wheel speed sensors that are configured to detect the rotational speeds of the vehicle's road wheels in the circumferential direction (e.g., rolling direction) and transmit them to the control device. Based on the recorded speeds, for example, the wheel-specific slip can be determined, which enables the vehicle to be characterized according to the respective driving situation.

In some examples, the vehicle and/or the SBW steering system includes wheel angle sensors. The wheel angle sensors are configured to detect a wheel angle of the steerable road wheels in relation to the steering axle of the respective steerable road wheels and to transmit it to a control device of the SBW steering system and/or the road wheel actuator. The control device and/or the road wheel actuator can consider the detected speeds and/or the detected wheel angles when estimating the rack and pinion force.

In some examples, the control device is at least coupled with a user interface. This allows the user inputs to be transmitted directly from the user interface to the control device. In addition, the control device can then immediately issue notifications to the driver via the user interface. In this sense, the user interface can be set up for bidirectional interaction with the driver. In some examples, the user interface can be a multimedia device that is configured to issue notifications to the driver and receive user input, such as audio-based or tactile inputs. Based on the user input, the driver can specify the desired driving mode and make additional detailed inputs and adjustments.

In some examples, the method also includes the following operations, the actual rack and pinion force applied by the road wheel actuator to a rack of the SBW steering system is estimated by the control device, an optimized rack and pinion force dependent on the operating parameters of the vehicle is estimated by the control device, and the torque steer fraction is estimated by subtracting the optimized rack and pinion force from the estimated actual rack force by the control device.

According to previous approaches, the control device has estimated the amount of torque to be applied to the rack by the road wheel actuator. In contrast, the control device and method described herein can determine an optimized rack and pinion force, which differs from the actual rack and pinion force and considers the respective operating parameters of the vehicle. As a result, there is a difference between the actual rack and pinion force applied and the optimized rack and pinion force. This difference can be determined by the control device and used to estimate the torque-steer portion. In such examples, the torque-steer portion of the feedback torque is therefore a measure of the divergence in the driving situation regarding the feedback at the steering wheel. It can therefore be used by the control device to provide the driver at the steering wheel with adapted torque feedback through the hand wheel actuator. As a result, the torque feedback for the driver depends on the respective driving situational operating parameters of the vehicle and the optimized rack and pinion force dependent on them, so that torque feedback that can reproduce the actual vehicle lateral control precisely and directly.

In some examples, the operating parameters of the vehicle include at least one of a vehicle speed, a yaw rate, a change in lateral speed (e.g., acceleration), a steering angle of a steerable road wheel around the respective wheel steering axle, and combinations thereof. For example, a rack and pinion sensor and/or the applied electrical power of the electric motor of the road wheel actuator can be used to estimate the actual rack and pinion force. The rack and pinion sensor can be configured to detect an output force from the road wheel actuator to the rack. Alternatively or additionally, the rack and pinion sensor may also include a position sensor that is set up to detect a rack position of the rack with respect to a reference position and transmit it to the control device. In an alternative, the actual rack and pinion force exerted by the road wheel actuator on the rack can also be estimated based on the operating parameters of the road wheel actuator, for example the current consumption and/or the voltage consumption (e.g., the electrical power consumption).

In some examples, the control device considers a model of the SBW steering system and/or the vehicle when estimating the optimized rack and pinion force. As a result, the control exercised by the control device is closely adapted to the structural implementation of the steering system. This allows the method and the control device to produce realistic steering behavior.

Alternatively or additionally, when estimating the optimized rack and pinion force, the control device considers at least one of a vehicle speed of the vehicle, a yaw rate, a change in transverse speed, or a steering angle of the steerable road wheels. These parameters can be used by the control device to determine the vehicle condition of the vehicle at any given time. Therefore, the optimized rack and pinion force can subsequently be determined in a tailor-made manner regarding the respective vehicle condition.

In some examples, the estimated rack and pinion force, optimized for the driving mode, is stored in a data memory coupled to the control device, which contains a database of feedback characteristics for the torque-steer portion of the feedback torque to be applied by the hand wheel actuator. This means that the optimized rack and pinion force estimated for the vehicle configuration, such as the driving mode, only needs to be determined once and can then be stored in the database for this vehicle configuration. If the same vehicle configuration occurs again in the future, the optimized rack and pinion force does not have to be estimated again. Instead, the control device can simply access the database and read the corresponding parameter values. In some examples, the method can also determine a feedback torque by adding the estimated torque steer fraction to the conventional feedback torque determined by the control device.

The SBW steering system includes a conventional control routine for determining a feedback torque for the steering wheel that reflects the lateral guidance of the vehicle, which is applied by the hand wheel actuator. This routine is used to determine the feedback torque that corresponds to a desired feedback torque, typically filtered by interference, based on the actual rack and pinion force output by the road wheel actuator. However, this routine does not consider driving mode-dependent modifications regarding the torque steer component. However, to provide the driver with more immediate and direct feedback about the vehicle's lateral guidance, a feedback torque is determined by the control device in accordance with the aspect explained above, which adds the torque steer portion to the conventional feedback torque. For example, the feedback torque for the driver at the steering wheel varies depending on the driving mode, which adjusts the intensity so that the feedback can be more direct than conventional SBW steering systems, for example, and can mimic the behavior of conventional steering systems with mechanical coupling and be sportier overall. This simplifies vehicle control for the driver compared to existing approaches.

In some examples, the method may also include estimating a torque steer percentage based on the estimated optimized rack and pinion force depending on the vehicle's operating parameters and determining a feedback torque by adding the estimated torque steer fraction to the determined conventional feedback torque.

This design is particularly advantageous for vehicles in which only small or no torque steer components are caused, such as vehicles with rear-wheel drive, which usually have a low rack-and-pinion interference force. Therefore, a torque steer percentage can be determined for such vehicles based on the estimated optimized rack and pinion force and depending on the operating parameters of the vehicle. This enables the feedback torque to simulate a sporty vehicle, for example, considering the torque steer component compared to conventional SBW steering systems.

In some examples, the method may also include determining a feedback torque by subtracting the estimated torque steer fraction from the determined conventional feedback torque. The routine used to determine the conventional feedback torque does not consider mode-dependent modifications to the torque-steer component. However, to provide the driver with more convenient feedback about the vehicle's lateral guidance, the control device determines a feedback torque. To do this, the control device subtracts the torque steer component from the estimated conventional feedback torque. For example, the feedback to the driver at the wheel can be reduced depending on the driving mode, thereby weakening the intensity, making the feedback more comfortable compared to conventional SBW steering systems, for example. As a result, vehicle control is less disruptive for the driver compared to existing approaches.

In some examples, the feedback torque is determined by the control device by subtracting the estimated preferred torque-steer fraction depending on the vehicle's operating parameters from the determined conventional feedback torque. As explained above, the preferred torque-steer proportion is determined by the control device on the basis of the optimized rack and pinion force. Overall, both the estimated torque-steer fraction or the preferred torque-steer fraction can be added or subtracted by the control device to the conventional feedback torque to determine the adapted feedback torque tailored to the driving mode.

The control device can, in some examples, also adjust the estimated torque-steer fraction or the preferred torque-steer fraction with regard to the specified riding mode before addition or subtraction and determine a torque-steer fraction optimized depending on the driving mode, which is then considered during addition or subtraction. For example, while the optimized rack and pinion force is initially determined independently of the specified driving mode, as it can be determined purely on the basis of the respective operating parameters of the vehicle, the consideration of the specified driving mode leads to an additional degree of freedom to adjust the feedback on the steering wheel in the way desired by the driver. This means that the user can in some examples specify whether the feedback torque output to the steering wheel is increased by addition or reduced by subtraction based on user input via the user interface. In some examples, this setting can also be made by the user depending on the driving mode.

A pre-factor is in some examples considered when determining the optimized torque steer portion by the control device, which depends on the driving mode. For example, the control device has a further degree of freedom to adjust the adaptation of the feedback to the operating state of the vehicle, for example regarding the strength of the adjustment. The driver's user input can affect different driving modes, such as a normal mode, a comfort mode, a sport mode and a race mode. In addition, the user input can In some examples specify intensity levels that specify the characteristics of the modes. In other words, the user input can also specify an intensity level of the driving mode. The intensity level indicates how comfortable or sporty the driver wants to receive feedback about the vehicle's lateral guidance. The driving modes and/or the intensity levels can be used to determine a pre-factor by the control device, which is considered when adding the estimated feedback torque. For example, the control device may be coupled to a database that has an assignment table with predetermined pre-factors associated with driving modes and/or intensity levels.

In some examples, the control device issues a notification to the user to hold the steering wheel with both hands, provided that the intensity level is greater than or equal to an intensity threshold and/or that specific driving modes are selected based on user input. The database may contain an assignment of the notification to be issued to corresponding driving modes and/or intensity levels. In some examples, the notification is issued to the driver via the user interface. For example, the notification can be output as a visual or auditory notification via a display and/or a speaker.

According to a further aspect, the disclosure also relates to a computer program product, comprising commands which, when executed by a computer, cause the computer to execute the method as described herein. The benefits achieved by the process described herein are also achieved in a corresponding manner by the computer program product. According to an additional aspect, the disclosure also relates to a non-transitory computer-readable storage medium, comprising commands which, when executed by a computer, cause the computer to execute the method as described herein. The advantages achieved by the process described herein are also achieved in a corresponding way by the computer-readable storage medium. According to another aspect, some examples of the disclosure relate to a vehicle with an SBW steering system as described herein. The advantages achieved by the SBW steering system described herein are also achieved in a corresponding way by the vehicle.

For the purposes of the disclosure, vehicles may include land vehicles, namely, inter alia, off-road and road vehicles such as passenger cars, buses, trucks, and other commercial vehicles. Vehicles can be manned or unmanned. The vehicles can at least be partially electrically driven (e.g., have an electric motor that serves as the drive). In addition, the vehicles can also have an optional combustion engine.

All the features explained with regard to the various aspects can be combined individually or in (sub-)combination with other aspects. The detailed description below, in conjunction with the accompanying drawings, in which the same numbers refer to the same elements, is intended as a description of different examples of the disclosed object and is not intended to represent the only examples. Each example described in this disclosure is intended only as an example or illustration and should not be construed as favored or advantageous over other examples. The illustrative examples contained herein do not claim to be exhaustive and do not limit the claimed subject matter to the exact disclosed forms. Variations of the examples described are readily recognizable to the skilled person and the general principles defined herein can be applied to other examples and applications without departing from the spirit and scope of the examples described. Therefore, the examples described are not limited to the examples shown, but have the widest possible scope of application that is compatible with the principles and characteristics disclosed here.

All the features disclosed below in relation to the examples and/or accompanying figures may be combined, alone or in any sub-combination, with features of the aspects of disclosure, including features of preferred examples, provided that the resulting combination of features is reasonable to a skilled person in the field of technology.

For the purposes of disclosure, the phrase "at least one of A, B and C" means, for example, (A), (B), (C), (A and B), (A and C), (B and C) or (A, B and C), including all other possible combinations if more than three elements are listed. In other words, the term "at least one of A and B" generally means "A and/or B", namely "A" alone, "B" alone or "A and B".

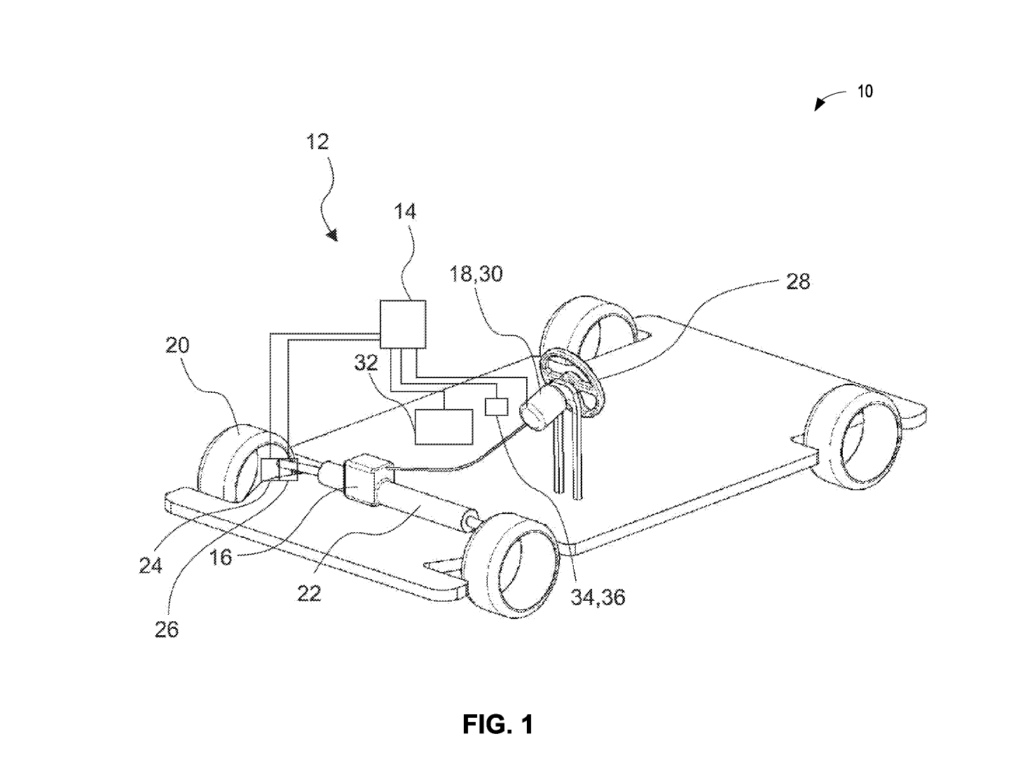

FIG. 1 shows a simplified schematic representation of a vehicle 10 with a SBW steering system 12 according to an example. The SBW steering system 12 includes a control device 14, a road wheel actuator 16, and a hand wheel actuator 18.

The road wheel actuator 16 is indirectly coupled with steerable road wheels 20 of the vehicle 10. For this purpose, the road wheel actuator 16 is coupled to a rack 22, which is coupled to the steerable road wheels 20 of the vehicle 10. The deflection of the rack 22 leads to a change in the orientation of the steerable road wheels 20 (e.g., a rotation of the steerable road wheels 20 around the vehicle's vertical axis).

The vehicle 10 also includes a wheel speed sensor 24. The wheel speed sensor 24 can also be part of the SBW steering system. The wheel speed sensor 24 is configured to detect a speed of the road wheels 20 in the circumferential direction and to transmit it to the control device 14. From this, for example, the wheel-specific slip of the control device 14 can be determined.

Furthermore, the vehicle 10 includes a wheel angle sensor 26, which can also be part of the SBW steering system 12. The wheel angle sensor 26 is configured to detect a wheel angle of the steerable road wheels 20 with respect to a reference position, such as a straight line, and to transmit the detected wheel angle to the control device 14. In the straight line, the steerable road wheels 20 are oriented parallel to the longitudinal direction of the vehicle 10. In some examples, an alternative sensor, such as a rack and pinion sensor, can also be coupled to rack 22 and detect the deflection of rack 22 with respect to a reference position, such as a center position. Since the rack 22 is coupled with the steerable road wheels 20, the orientation of the steerable road wheels can also be determined.

The SBW steering system 12 also includes a steering wheel 28, to which the hand wheel actuator 18 is at least indirectly coupled, for example via a steering column. The hand wheel actuator 18 is configured to exert feedback torque on the steering wheel 28 so that the driver of vehicle 10 is given a feeling about the lateral guidance of vehicle 10.

The hand wheel actuator 18 includes an electric motor. The electric motor of the hand wheel actuator 18 includes at least one winding set. Each winding set of the electric motor is three-phase and configured to drive a rotor of the electric motor. As a result, feedback torque can be provided to the driver on the steering wheel 28 of the vehicle 10 by the electric motor to give the driver a feeling about the lateral control of vehicle 10. Using the steering wheel 28, a driver of the vehicle can provide steering inputs for the vehicle 10.

In addition, the SBW steering system 12 includes at least one steering wheel sensor 30, which is configured to detect a steering wheel angle (e.g., steering wheel position) of the steering wheel 28 in relation to a reference position, for example a center orientation (e.g., zero position). Consequently, the steering wheel sensor 30 can be used to detect the steering inputs of the driver of the vehicle 10 using the steering wheel 28. According to this example, the steering wheel sensor 30 is integral with the hand wheel actuator 18. In other examples, however, the steering wheel sensor 30 can also be separated from the hand wheel actuator 18. The steering wheel sensor 30 is configured to transmit the detected steering wheel angle to the control device 14.

In some examples, when issuing the wheel alignment signal to the road wheel actuator 16, the control device 14 can consider other parameters of the vehicle 10, such as vehicle speed or speed change values. These values can also be considered when regulating the feedback torque applied to the steering wheel 28 by the hand wheel actuator 18 (e.g., when issuing the hand wheel actuator signal).

The vehicle 10 also includes a user interface 32, which is coupled with the control device 14. Between the user interface 32 and the control device 14, notifications for the vehicle user or user input from the vehicle user can be transmitted bidirectionally. This means that the control device can issue 14 notifications to the vehicle user using user interface 32 and can receive user input via user interface 32. In some examples, the user interface 32 can be configured as part of the SBW steering system 12. In general, however, the user interface 32 is configured in such a way, for example by means of a multimedia device, that the driver can use the user interface 32 to use other functionalities of the vehicle 10, such as air conditioning or entertainment functions. According to this example, the user of vehicle 10 may, via the user interface 32, at least transmit user inputs to the control device 14 in such a way that the user of vehicle 10 thereby specifies a desired driving mode and, In some examples, also a desired intensity level of the respective driving mode. The selectable driving modes include, for example, a sport mode and a race mode. In some examples, the driving mode can also include a conventional normal mode or a comfort mode. The intensity level represents a fine gradation of the driving mode. The driving mode and/or intensity level indicate how directly and immediately the driver wants feedback at the steering wheel 28 in the form of a feedback torque for the vehicle's lateral control.

The SBW steering system 12 also includes at least one data storage 34, which is coupled with the control device 14. The data storage 34 includes at least one database 36 in which feedback characteristics are stored. The feedback characteristics indicate the feedback torque to be applied to the steering wheel 28 by the hand wheel actuator 18. Feedback characteristics may be provided which depend on various parameters, such as the steering wheel angle, which can be detected via the steering wheel sensor 30, the wheel angle of the steerable road wheels 20, which can be detected by means of the edge angle sensors 26, the vehicle speed of the vehicle 10, which can be determined indirectly, for example, via the wheel speed sensors 24, and the rack and pinion force applied by the road wheel actuator 16 to the rack 22. The rack and pinion force applied by the road wheel actuator 16 can be determined, for example, by the operating parameters of the road wheel actuator 16. For this purpose, it is possible, for example, to record the electrical voltage and current absorbed by the road wheel actuator 16, and in general what the electrical power consumption of the road wheel actuator 16 is. In some examples, the rack force applied by the road wheel actuator 16 to rack 22 can also be determined using a dedicated sensor that is part of the SBW steering system 12, such as a rack and pinion sensor.

The control device 14 emits a wheel alignment signal to control the road wheel actuator 16. Based on the wheel alignment signal, an output torque to be output by the road wheel actuator 16 is requested. The output torque is exerted by the road wheel actuator 16 to the rack 22 in the form of a rack and pinion force, so that a deflection of the steerable road wheels 20 is indirectly changed. In determining the required rack and pinion force, control device 14 considers the steering input on the steering wheel 28 and also the driving mode desired by the driver and/or the intensity level specified by the driver of vehicle 10 on the basis of the user input.

To control the hand wheel actuator 18, the control device 14 emits a steering wheel control signal. Based on the steering wheel signal, a feedback torque to be output by the hand wheel actuator 18 is requested. The hand wheel actuator 18 then outputs the feedback torque, which at least indirectly influences the orientation of the steering wheel 28.

The SBW steering system 12 can include several components of the same type and generally the same function, for example several steering wheel sensors 30, which ensures redundancy. Here the SBW steering system 12 is shown as front-axle steering. The vehicle 10 and the SBW steering system 12 can in some examples also have other steerable road wheels 20, such as rear wheels coupled to an additional common road wheel actuator 16.

Each road wheel actuator 16 includes an electric motor. The electric motor includes at least one winding set that includes a group of windings. Each winding set is configured so that phase currents are generated in the underlying windings when supplied with supply signals, such as phase voltages, which can be used to drive a rotor of the electric motor. The rotor can then be coupled with a corresponding component of the SBW steering system 12, such as the rack 22, and thus enable the movement of the steerable road wheels 20. In general, the electric motor can also include more than one winding set. Typically, each winding set is three-phase, so that the electric motor is configured as a whole at least three-phase, In some examples also six-phase or nine-phase. If there are several winding sets, the winding sets allow the rotor of the electric motor to move independently of other winding sets. This means that the winding sets are separate from each other.

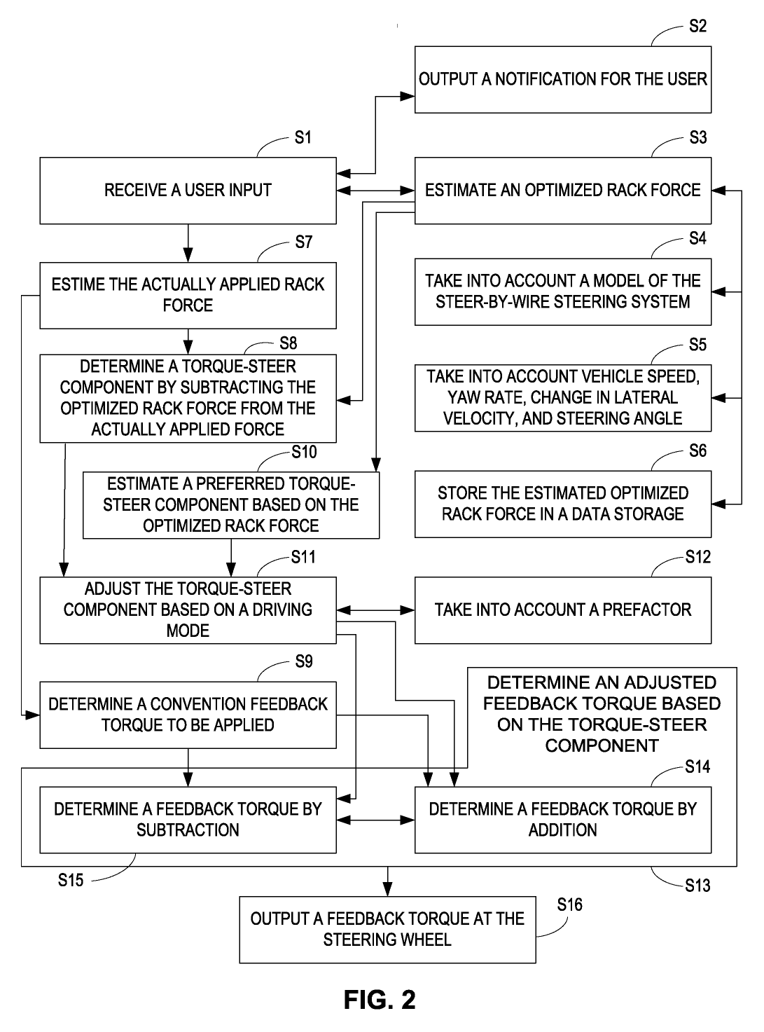

FIG. 2 is a flowchart representative of example machine readable instructions and/or example operations that may be executed, instantiated, and/or performed by example programmable circuitry to implement the control device 14 of FIG. 1. Optional operations are shown in dashed form. The method first includes operation S1, in which a user input is received by the control device 14 via the user interface 32. At least one driving mode desired by the driver is specified based on the user input. This informs the control device 14 of the way in which the feedback for the driver of vehicle 10 on the steering wheel 28 is to be adapted.

Operation S1 can be further implemented by the optional operation S2 in that the control device 14 issues a notification to the user to hold the steering wheel 28 with both hands if the intensity level is greater than or equal to an intensity threshold and/or if the driver inputs a predetermined driving mode for which this notification is intended by the user input. The notification may be issued by the control device 14 to the driver of the vehicle 10 by means of user interface 32.

Since the intensity level selected by the driver of vehicle 10 has an influence on the feedback on the steering wheel 28, in some examples it may be required that the driver of vehicle 10 holds the steering wheel 28 with both hands, for example, to be able to withstand particularly high feedback torques and to be able to adjust the lateral guidance of vehicle 10 according to his wishes, although a particularly sporty and direct feedback by the driver is chosen.

Starting from operation S1, the method can include the optional operation S3, in which the optimized rack and pinion force to be applied by the road wheel actuator 16 to the rack 22 of the SBW steering system 12 is estimated by the control device 14. The determination of the optimized rack and pinion force in operation S3 therefore makes it possible to simulate a torque-steer component of a conventional steering system (e.g., a non-SBW steering system with a direct mechanical coupling between the steering wheel 28 and the steerable road wheels 20). For example, the optimized rack and pinion force of the control device 14 can be determined in such a way that it is modelled on the rack and pinion force applied to conventional steering systems of vehicles operated at the physical limit.

Operation S3 can be further implemented by the optional operation S4, in which the control device 14 considers a model of the SBW steering system 12 and/or the vehicle 10 when estimating the optimized rack and pinion force. This allows the control device 14 to consider how the power is transferred from individual components of the SBW steering system 12 to other components of it. For example, friction effects can also be considered in this way. In the end, the model of the SBW steering system 12 that uses the control device 14 is tailor-made for the respective SBW steering system 12.

Operation S3 can also be further implemented by the optional operation S5, in that the control device 14 takes into account the vehicle speed of the vehicle 10, the yaw rate, the transverse speed change, and/or the steering angle of the steerable road wheels 20 around the respective wheel steering axles when determining the optimized rack and pinion force. For example, the steering angle of the steerable road wheels 20 can be detected via the wheel angle sensors 26. The vehicle speed of the vehicle 10 can be determined, at least indirectly via the wheel speed sensors 24. To determine the yaw rate and/or the change in lateral speed, the SBW steering system 12 can have additional sensors or can use sensors that the vehicle 10 already has. These parameters can be used to optimize the determination of the optimized rack and pinion force depending on the driving situation, so that the determination is more precise.

In addition, the method can include the optional operation S6, in which the optimized rack and pinion force is stored in the data memory 34 coupled with the control device 14. The data memory 34 includes a database 36 of feedback characteristics for the feedback torque to be applied by the hand wheel actuator 18. This allows a torque steer fraction to be simulated for vehicles 10 that typically provide little or no torque feedback to the driver, such as rear-wheel drive vehicles 10.

Starting from operation S1, the method also includes the optional operation S7, in which the actual rack force applied by the road wheel actuator 16 to a rack 22 of the SBW steering system 12 is estimated. This can be determined, for example, by the operating parameters of the road wheel actuator 16, which can be detected by corresponding sensors and transmitted to the control device 14. For example, the electrical power consumption of the road wheel actuator 16 can be evaluated.

Starting from the optional operations S3 and S7, the method includes the optional operation S8. In operation S8, a torque-steer fraction is estimated by the control device 14 by subtracting the optimized rack and pinion force from the estimated actual rack and pinion force. The torque steer fraction is a measure of the divergence between the actual rack and pinion force applied and the optimized rack and pinion force. This difference can then be used indirectly to adjust the feedback torque on the steering wheel 28 in a tailor-made way.

In addition, the method includes operation S9, which follows the optional operation S7. In operation S9, the conventional feedback torque to be applied by the hand wheel actuator 18 is determined by the control device 14 based on the actual rack and pinion force applied. In some examples, other parameters can also be considered, such as vehicle speed, lateral speed change, yaw rate and/or wheel angle. This is therefore the conventional determination of the feedback torque to be applied from the hand wheel actuator 18 to the steering wheel 28 and corresponds to the normal operating state of the SBW steering system 12 outside the method explained here. Due to the difference between the rack and pinion force actually applied by the road wheel actuator 16 and the optimized rack and pinion force, an adjustment of the feedback torque to be applied by the hand wheel actuator 18 to the steering wheel 28 is now determined.

Therefore, following the optional operation S3, the method includes the optional operation S10, in which the control device 14 estimates a preferred torque-steer fraction based on the estimated optimized rack and pinion force depending on the operating parameters of the vehicle 10. In other words, as an alternative and/or as a comparative variable and/or as a plausibility criterion to the estimated torque-steer fraction from operation S8, the torque-steer fraction can be estimated even while neglecting the rack-and-pinion force applied by the control device 14. To this end, the control device 14 only considers the optimized rack and pinion force from the optional operation S3 and, In some examples, the other operating parameters of the vehicle from the optional operations S4 to S6. For example, this enables an estimation of the torque-steer fraction independently of the actual rack and pinion force applied.

The method can then include the optional operation S11 starting from operations S8 and S10. In operation S11, the control device 14 can optimize the determined torque-steer fraction, regardless of how it is estimated (e.g., on the basis of a subtraction according to S8 or on the basis of only the optimized rack and pinion force according to S3), with respect to the driving mode selected in operation S1. This means that the control device 14 estimates an optimized torque steer percentage depending on the driving mode. The estimated torque-steer components from operations S8 and S10, on the other hand, have no or only an indirect driving mode dependency. Since the driver defines a specific type of feedback on the steering wheel 28 based on the user input, such as a driving mode and/or an intensity level of feedback, this has an influence on the sportiness of the lateral control of the vehicle 10. This is used by the control device 14 in the optional operation S11 to determine the torque-steer proportion optimized for the respective setting desired by the user, which must be considered to adjust the feedback torque.

For example, the optional operation S11 can be further implemented by the optional operation S12, in which the control device 14 considers a pre-factor when estimating the optimized torque steer percentage. This results in the torque steer component being artificially amplified or weakened so that it can be tailored to the respective SBW steering system 12. In this context, the pre-factor may be based on the driving mode and/or intensity level specified by the user input. In some examples, the user input can also specify further information, such as the desired strength of the feedback on the steering wheel 28, which allows the pre-factor to be determined. The data memory 34 can have corresponding information about the prefactor. This enables a tailor-made estimation of the torque steer content.

To adapt the feedback for the driver at the steering wheel 28, the method includes operation S13 based on operations S9 and S11. In operation S13, the control device 14 determines a feedback torque that is adjusted for the optimized torque steer percentage, which in turn depends on the driving mode specified by the driver according to operation S1. The method enables both the reinforcement of feedback at the steering wheel 28 (e.g., more direct feedback behavior) and the weakening of the feedback (e.g., less direct feedback behavior). Therefore, the operation S13 can also be configured in different ways, depending on the desired driving mode and/or the driving situation of the vehicle 10.

According to the optional operation S14 as part of operation S13, the control device 14 determines the adjusted feedback torque to be applied from the hand wheel actuator 18 to the steering wheel 28 by adding the estimated optimized torque steer fraction from the optional operation S10 to the conventional feedback torque determined by the control device 14. This reinforces the feedback. The driver perceives this as a more direct feedback behavior at the steering wheel 28 with regard to the lateral control of the vehicle 10.

As an alternative, operation S13 may also include optional operation S15, in which the control device 14 subtracts the estimated, optimized torque steer portion from the determined conventional feedback torque to determine the adjusted feedback torque. This weakens the feedback. The driver perceives this as less direct feedback behavior at the steering wheel 28 regarding the lateral control of the vehicle 10.

The estimated optimized torque-steer percentage in operations S14 and S15 can be based on both the estimated torque-steer percentage from operation S8 and the preferred torque-steer percentage from operation S14. Corresponding preliminary factors from operation S12 can also be considered. Whether the feedback torque on the steering wheel 28 is increased or reduced for the driver according to the optional operations S14 or S15 can be specified by the user input using the user interface 32 in accordance with operation S1.

In the subsequent operation S16, the correspondingly adjusted feedback torque is output by the hand wheel actuator 18 on the steering wheel 28. For this purpose, the control device 14 emits a corresponding steering wheel control signal to the hand wheel actuator 18. In particular, the feedback torque applied by the hand wheel actuator 18 to the steering wheel 28 is adjusted by the optimized torque-steer component, corresponding to the optional operation S14 or S15.

Thus, an SBW steering system 12 and a method are provided that make it possible to adapt the feedback to the driver at the steering wheel 28 in a tailor-made manner depending on the driving mode chosen by the driver of the vehicle 10 and/or the intensity level. This allows a torque-steer portion of conventional steering systems to be simulated with a mechanical connection between the steering wheel 28 and the steerable road wheels 20. In this way, depending on the user's input, feedback can be achieved that is sporty and direct or more comfortable (e.g., less direct).

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

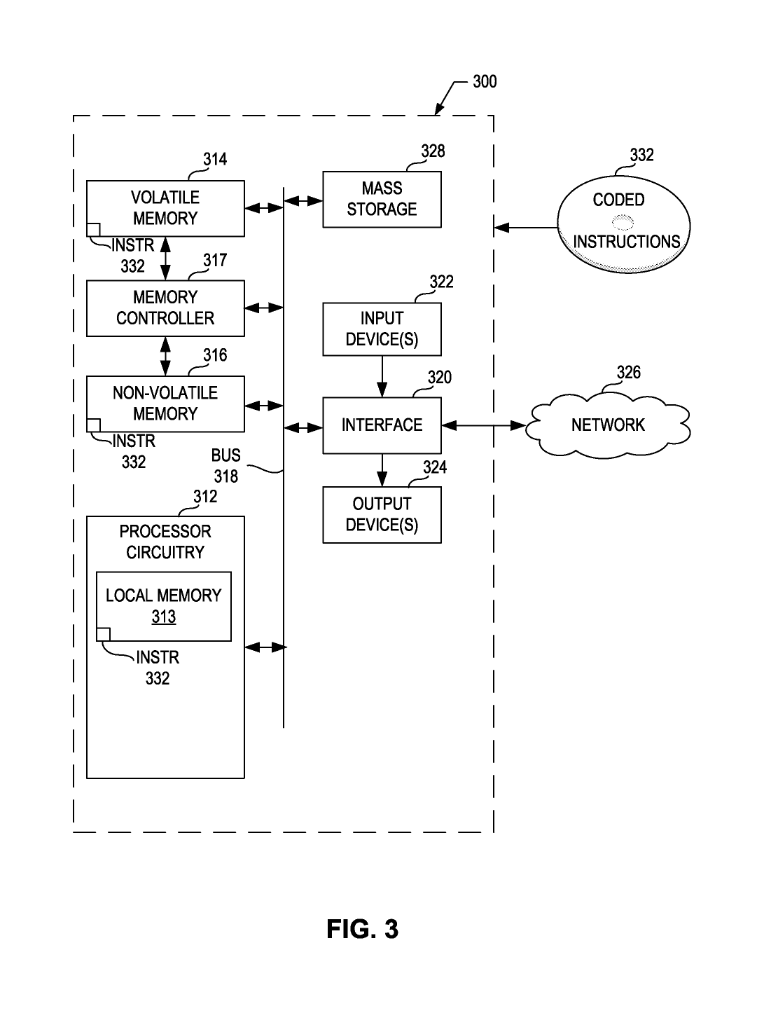

FIG. 3 is a block diagram of an example programmable circuitry platform 300 structured to execute and/or instantiate the example machine-readable instructions and/or the example operations of FIG. 2 to implement examples disclosed herein. The programmable circuitry platform 300 can be, for example, a control device, an electronic control unit (ECU), a self-learning machine (e.g., a neural network), or any other type of computing and/or electronic device.

The programmable circuitry platform 300 of the illustrated example includes programmable circuitry 312. The programmable circuitry 312 of the illustrated example is hardware. For example, the programmable circuitry 312 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 312 may be implemented by one or more semiconductor based (e.g., silicon based) devices.

The programmable circuitry 312 of the illustrated example includes a local memory 313 (e.g., a cache, registers, etc.). The programmable circuitry 312 of the illustrated example is in communication with main memory 314, 316, which includes a volatile memory 314 and a non-volatile memory 316, by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317. In some examples, the memory controller 317 may be implemented by one or more integrated circuits, logic circuits, microcontrollers from any desired family or manufacturer, or any other type of circuitry to manage the flow of data going to and from the main memory 314, 316.

The programmable circuitry platform 300 of the illustrated example also includes interface circuitry 320. The interface circuitry 320 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 322 are connected to the interface circuitry 320. The input device(s) 322 permit(s) a user (e.g., a human user, a machine user, etc.) to enter data and/or commands into the programmable circuitry 312. The input device(s) 322 can be implemented by, for example, an audio sensor, a microphone, a camera (still or video), a button, a touchscreen, and/or a voice recognition system.

One or more output devices 324 are also connected to the interface circuitry 320 of the illustrated example. The output device(s) 324 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 300 of the illustrated example also includes one or more mass storage discs or devices 328 to store firmware, software, and/or data. Examples of such mass storage discs or devices 328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 332, which may be implemented by the machine-readable instructions of FIG. 2, may be stored in the mass storage device 328, in the volatile memory 314, in the non-volatile memory 316, and/or on at least one non-transitory computer readable storage medium such as a CD or DVD which may be removable.

Specific examples disclosed herein use circuits (e.g., one or more circuits) to implement standards, protocols, methods, or technologies disclosed here, to functionally couple two or more components, to generate information, to process information, to analyze information, to generate signals, to encode/decode signals, to convert signals, to transmit and/or receive signals, to control other devices, etc. Circuits of any kind can be used.

In one example, a circuit such as the control device comprises, among other things, one or more data processing devices such as a processor (e.g., a microprocessor), a central processing unit (CPU), a digital signal processor (DSP), an application-specific integrated circuit (ASIC), a field-programmable gate array (FPGA), a system on a chip (SoC), or similar, or any combination thereof, and can contain discrete digital or analog devices. circuit elements or electronics or combinations thereof. In an example, circuit includes hardware circuit implementations (e.g., implementations in analog circuits, implementations in digital circuits, and the like, and combinations thereof).

In an example, circuits include combinations of circuits and computer program products with software or firmware instructions stored on one or more computer-readable memories that work together to cause a device to execute one or more of the protocols, procedures, or technologies described herein. In an example, circuit engineering includes circuits, such as microprocessors or parts of microprocessors, that require software, firmware, and the like to operate. In an example, the circuits comprise one or more processors or parts thereof and the associated software, firmware, hardware, and the like.

This disclosure can refer to quantities and numbers. Unless expressly stated, such quantities and figures are not to be regarded as limiting, but as examples of the possible quantities or figures in connection with the disclosure. In this context, the term "plural" can also be used to refer to a quantity or number. In this context, the term "plural" refers to any number that is greater than one, e.g. two, three, four, five, etc. The terms "approximately", "approximately", "near", etc. mean plus or minus 5% of the stated value.

Although the disclosure has been presented and described in relation to one or more examples, after reading and understanding this description and the accompanying drawings, the skilled person will be able to make equivalent changes and modifications. Further examples and combinations thereof include the following:

Example 1 includes a vehicle comprising a hand wheel actuator, a road wheel actuator, and a control device configured to determine a first feedback torque to be applied by the hand wheel actuator based on an actual rack and pinion force applied by the road wheel actuator, determine a second feedback torque to be applied by the hand wheel actuator based on the first feedback torque and a driving mode associated with the vehicle, and cause the hand wheel actuator to generate a feedback torque to a steering wheel of the vehicle based on the second feedback torque.

Example 2 includes the vehicle of example 1, wherein the control device is configured to estimate an optimized rack and pinion force applied by the road wheel actuator based on operating parameters associated with the vehicle, and determine the second feedback torque further based on a difference between the actual rack and pinion force and the optimized rack and pinion force.

Example 3 includes the vehicle of example 2, wherein the operating parameters include at least one of a speed or an acceleration of the vehicle.

Example 4 includes the vehicle of any one or more of examples 2-3, wherein the operating parameters include a yaw rate of the vehicle.

Example 5 includes the vehicle of any one or more of examples 2-4, wherein the operating parameters include a steering angle of the vehicle.

Example 6 includes the vehicle of any one or more of examples 2-5, wherein the control device is configured to estimate the optimized rack and pinion force further based on a model of a steering system of the vehicle.

Example 7 includes the vehicle of any one or more of examples 1-6, wherein the control device is configured to generate a notification to a user interface of the vehicle based on the driving mode.

Example 8 includes a non-transitory computer readable storage medium comprising instructions to cause at least one programmable circuitry to determine a first feedback torque to be applied by a hand wheel actuator of a vehicle based on an actual rack and pinion force applied by a road wheel actuator of the vehicle, determine a second feedback torque to be applied by the hand wheel actuator based on the first feedback torque and a driving mode associated with the vehicle, and cause the hand wheel actuator to generate a feedback torque to a steering wheel of the vehicle based on the second feedback torque.

Example 9 includes the non-transitory computer readable storage medium of example 8, wherein the at least one programmable circuitry is to estimate an optimized rack and pinion force applied by the road wheel actuator based on operating parameters associated with the vehicle, and determine the second feedback torque further based on a difference between the actual rack and pinion force and the optimized rack and pinion force.

Example 10 includes the non-transitory computer readable storage medium of example 9, wherein the operating parameters include at least one of a speed or an acceleration of the vehicle.

Example 11 includes the non-transitory computer readable storage medium of any one or more of examples 9-10, wherein the operating parameters include a yaw rate of the vehicle.

Example 12 includes the non-transitory computer readable storage medium of any one or more of examples 9-11, wherein the operating parameters include a steering angle of the vehicle.

Example 13 includes the non-transitory computer readable storage medium of any one or more of examples 9-12, wherein the at least one programmable circuitry is to estimate the optimized rack and pinion force further based on a model of a steering system of the vehicle.

Example 14 includes the non-transitory computer readable storage medium of any one or more of examples 8-13, wherein the at least one programmable circuitry is to generate a notification to a user interface of the vehicle based on the driving mode.

Example 15 includes a method comprising determining a first feedback torque to be applied by a hand wheel actuator of a vehicle based on an actual rack and pinion force applied by a road wheel actuator of the vehicle, determining a second feedback torque to be applied by the hand wheel actuator based on the first feedback torque and a driving mode associated with the vehicle, and causing the hand wheel actuator to generate a feedback torque to a steering wheel of the vehicle based on the second feedback torque.

Example 16 includes the method of example 15, further including estimating an optimized rack and pinion force applied by the road wheel actuator based on operating parameters associated with the vehicle, and determining the second feedback torque further based on a difference between the actual rack and pinion force and the optimized rack and pinion force.

Example 17 includes the method of example 16, wherein the operating parameters include at least one of a speed or an acceleration of the vehicle.

Example 18 includes the method of any one or more of examples 16-17, wherein the operating parameters include a yaw rate of the vehicle.

Example 19 includes the method of any one or more of examples 16-18, wherein the operating parameters include a steering angle of the vehicle.

Example 20 includes the method of any one or more of examples 16-19, further including estimating the optimized rack and pinion force further based on a model of a steering system of the vehicle.

What is claimed is:

1. A vehicle comprising:
a hand wheel actuator;
a road wheel actuator; and
a control device configured to:
determine a first feedback torque to be applied by the hand wheel actuator based on an actual rack and pinion force applied by the road wheel actuator;
determine a second feedback torque to be applied by the hand wheel actuator based on the first feedback torque and a driving mode associated with the vehicle; and
cause the hand wheel actuator to generate a feedback torque to a steering wheel of the vehicle based on the second feedback torque.

2. The vehicle of claim 1, wherein the control device is configured to:
estimate an optimized rack and pinion force applied by the road wheel actuator based on operating parameters associated with the vehicle; and
determine the second feedback torque further based on a difference between the actual rack and pinion force and the optimized rack and pinion force.

3. The vehicle of claim 2, wherein the operating parameters include at least one of a speed or an acceleration of the vehicle.

4. The vehicle of claim 2, wherein the operating parameters include a yaw rate of the vehicle.

5. The vehicle of claim 2, wherein the operating parameters include a steering angle of the vehicle.

6. The vehicle of claim 2, wherein the control device is configured to estimate the optimized rack and pinion force further based on a model of a steering system of the vehicle.

7. The vehicle of claim 1, wherein the control device is configured to generate a notification to a user interface of the vehicle based on the driving mode.

8. A non-transitory computer readable storage medium comprising instructions to cause at least one programmable circuitry to:
determine a first feedback torque to be applied by a hand wheel actuator of a vehicle based on an actual rack and pinion force applied by a road wheel actuator of the vehicle;
determine a second feedback torque to be applied by the hand wheel actuator based on the first feedback torque and a driving mode associated with the vehicle; and
cause the hand wheel actuator to generate a feedback torque to a steering wheel of the vehicle based on the second feedback torque.

9. The non-transitory computer readable storage medium of claim 8, wherein the at least one programmable circuitry is to:
estimate an optimized rack and pinion force applied by the road wheel actuator based on operating parameters associated with the vehicle; and
determine the second feedback torque further based on a difference between the actual rack and pinion force and the optimized rack and pinion force.

10. The non-transitory computer readable storage medium of claim 9, wherein the operating parameters include at least one of a speed or an acceleration of the vehicle.

11. The non-transitory computer readable storage medium of claim 9, wherein the operating parameters include a yaw rate of the vehicle.

12. The non-transitory computer readable storage medium of claim 9, wherein the operating parameters include a steering angle of the vehicle.

13. The non-transitory computer readable storage medium of claim 9, wherein the at least one programmable circuitry is to estimate the optimized rack and pinion force further based on a model of a steering system of the vehicle.

14. The non-transitory computer readable storage medium of claim 8, wherein the at least one programmable circuitry is to generate a notification to a user interface of the vehicle based on the driving mode.

15. A method comprising:
determining a first feedback torque to be applied by a hand wheel actuator of a vehicle based on an actual rack and pinion force applied by a road wheel actuator of the vehicle;
determining a second feedback torque to be applied by the hand wheel actuator based on the first feedback torque and a driving mode associated with the vehicle; and
causing the hand wheel actuator to generate a feedback torque to a steering wheel of the vehicle based on the second feedback torque.

16. The method of claim 15, further including:
estimating an optimized rack and pinion force applied by the road wheel actuator based on operating parameters associated with the vehicle; and
determining the second feedback torque further based on a difference between the actual rack and pinion force and the optimized rack and pinion force.

17. The method of claim 16, wherein the operating parameters include at least one of a speed or an acceleration of the vehicle.

18. The method of claim 16, wherein the operating parameters include a yaw rate of the vehicle.

19. The method of claim 16, wherein the operating parameters include a steering angle of the vehicle.

20. The method of claim 16, further including estimating the optimized rack and pinion force further based on a model of a steering system of the vehicle.
